(19) United States
(12) Patent Application Publication
(10) Pub. No.: US 2011/0193359 A1
(43) Pub. Date: Aug. 11, 2011

(54) PORTABLE PET WASTE REMOVAL DEVICE

(75) Inventor: Vincent Howard, Beverly Hills, CA (US)

(73) Assignee: PALOMA'S PET PRODUCTS, INC., DBA PALOMA'S PETS, Beverly Hills, CA (US)

(21) Appl. No.: 12/704,419

(22) Filed: Feb. 11, 2010

(51) Int. Cl. A01K 29/00

(52) U.S. Cl. 294/1.3

(57) ABSTRACT

A waste removal device is described that comprises a handle having a movable actuation trigger, and two opposing jaws, wherein the jaws are adjacent each other in a closed condition when no external force is applied to the actuation trigger. The jaws are urged apart to an open condition when the trigger is actuated by a user. At least two clasps for clasping a portion of a plastic bag are provided, each clasp comprising a sheet of flexible material defining an elongate non-linear slot, the slot being sufficiently long to receive through the slot at least two fingertips of a user's hand.

### FIELD OF THE DEVICE

This invention relates to a mechanical device for lifting and removing pet waste that is commonly known as a pooper scooper. Specifically, the application relates to mechanisms for robustly and repeatedly opening jaws of the device, for attaching a plastic bag to cover the jaws of the device before the device is used, and also for safely storing the waste after it is collected but before it is disposed of.

### BACKGROUND

Mechanical pooper scoopers with grasping jaws are known and are described in the art. An important reason for using such a mechanical scooping device is that the user may hope to keep his hands clean when picking up and removing pet waste. However, in the typical case, the jaws of the device may become contaminated because they are unprotected and may come in direct contact with the waste material. As such, the device will rapidly become a hygiene problem in the user's home. Thus, the user may be obliged to clean the device, thereby reversing the gains of using such a device in the first place because the user's hands may become contaminated at this stage—the very result the device is designed to avoid.

There are devices available on the market today that make use of plastic bags that are installed on the grasping jaws in an effort to protect the jaws from contamination. However, a persistent problem in these devices is to attach the plastic bag easily to the exterior of the jaws without the risk of the bag becoming detached during use, or prior to use. Even where mechanical clips are provided to hold the plastic bag in the prior art, engaging the bag with the clips may require the use of two hands, and such clips are often not successful at holding the bag securely in place during use.

Another problem encountered with devices in the prior art is that, where the grasping jaws of the device close automatically when the user releases an actuation trigger of the device, the user is confronted with the problem that, while he is attempting to install a plastic bag on the open jaws, the jaws will tend to snap closed under the urging of a spring force and make the task very awkward. A further problem encountered by devices in the prior art is that, once the user has successfully captured pet waste between the jaws, the jaws may tend to swing open—with potentially disastrous results if the waste has not yet been disposed of.

Yet a further problem encountered with devices in the prior art is that mechanisms configured to open opposed grasping jaws may not be sufficiently robust to endure the rough treatment and impact loads that such devices are subject to over an extended lifetime.

Thus there is a need in the art for a portable pet waste removal device with grasping jaws that will address these problems. The present inventions address these and other needs.

### SUMMARY OF THE INVENTION

In a preferred embodiment of the invention, a portable waste removal device having features of the present invention is described. The device comprises a handle having a movable actuation trigger. Two opposing jaws are provided that are configurable in two different conditions. First, the jaws are adjacent each other in a closed condition when no external force is applied to the actuation trigger. Second, the jaws are urged apart to an open condition when the actuation trigger is moved under force by a user. The device includes at least two clasps for clasping a plastic bag to partially surround the device. The clasps are situated on opposite sides of the device, and each clasp comprises a sheet of flexible material defining an elongate non-linear slot. The slot is sufficiently long to receive through the slot at least two fingertips of a user's hand. In a preferred aspect of the invention, the non-linear slot has a wave like shape, and the flexible material is a polymer material. This configuration provides a novel and useful structure for capturing and securely clasping a plastic bag over the jaws of the device while pet waste is being collected for removal.

In another aspect of the invention, the device further includes a pivoting button attached to the device. The button has three settings, namely, a first setting configured to lock the jaws in a closed condition, a second setting permitting the jaws to be moved from a closed condition to an open condition and back to a closed condition, and a third setting configured to lock the jaws in an open condition. These three settings (a) allow a user to lock the jaws in an open condition while installing a plastic bag over the jaws; (b) allow the jaws to be manually opened and closed while collecting pet waste for removal; and (c) allow a user to lock the jaws in a closed condition once the pet waste has been collected, before it has been disposed of. These settings permit convenient installation of a plastic bag over the jaws when they are open, collection of the waste, and securing the jaws closed with the entrapped waste inside before disposing of the waste.

In yet another aspect of the invention, the device includes a novel and useful mechanism for moving the opposing jaws from a closed to an open condition. The mechanism includes a plunger configured to move linearly downwardly upon actuation of the trigger. The plunger defines a wedge shaped structure configured to force the two jaws to rotate about a common axis of rotation when the plunger is moved downwardly, whereby the jaws move apart from each other.

A further aspect of the invention is that it includes a hollow cylinder within the device for storing a roll of plastic bags. Preferably, the hollow cylinder defines a slot that provides a passage from the interior of the cylinder to a space between the two jaws, so that the roll of plastic bags is capable of being unraveled and withdrawn by a user through the slot into the space between the two jaws.

These and other advantages of the invention are described below in the detailed description of the preferred embodiments, with reference to the drawings.

### BRIEF DESCRIPTION OF THE DRAWINGS

FIG. 1 is a perspective view of a pet waste removal device having features of the present invention, shown in a closed condition.

FIG. 2 is a perspective view of the device in FIG. 1, shown in an open condition.

FIG. 3 is a perspective view, from below, of the device as seen in FIG. 2

FIG. 4 is a perspective exploded view of the device of FIG. 1, showing internal components of the device.

FIG. 5 is partial cutaway view of the device of FIG. 1, showing an actuation mechanism.

FIG. 6 is a detailed view of a portion of FIG. 5.

FIG. 7 is a perspective view of the device shown in FIG. 2 in an open configuration, and having a plastic bag mounted on, and attached to, the device.

FIG. 8 is a perspective partial cutaway view, showing a mechanism of the device of FIG. 1 in a first condition.

FIG. 9 is a perspective partial cutaway view, showing a mechanism of the device of FIG. 1 in a second condition.

FIG. 10 is a perspective partial cutaway view, showing a mechanism of the device of FIG. 1 in a third condition.

FIG. 11 is a perspective partial cutaway view, showing a mechanism of the device of FIG. 1 in a fourth condition.

### DETAILED DESCRIPTION OF THE PREFERRED EMBODIMENTS

With reference to the drawings, which are shown by way of exemplification and not limitation, there is described a mechanical device for removing pet waste having features of the present invention.

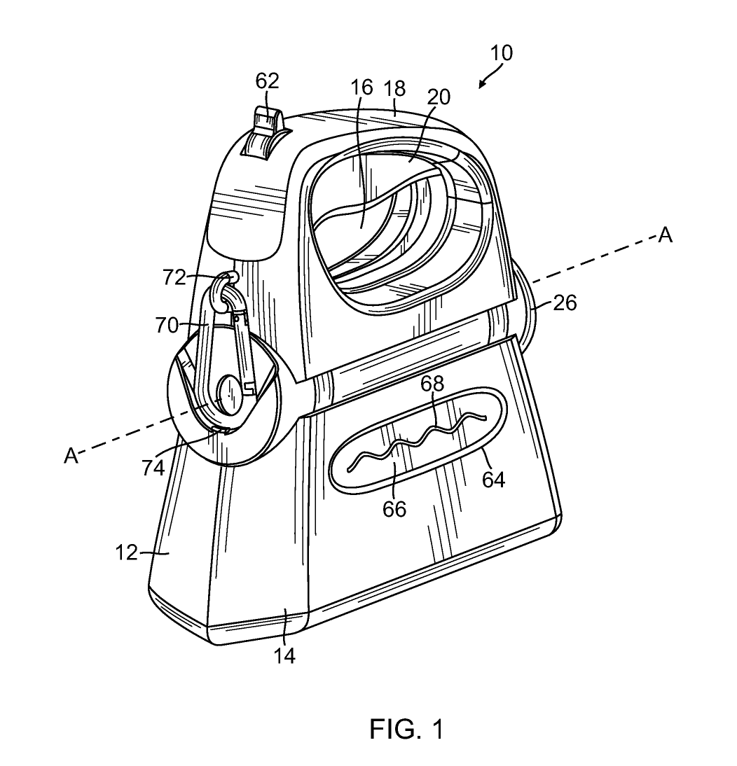

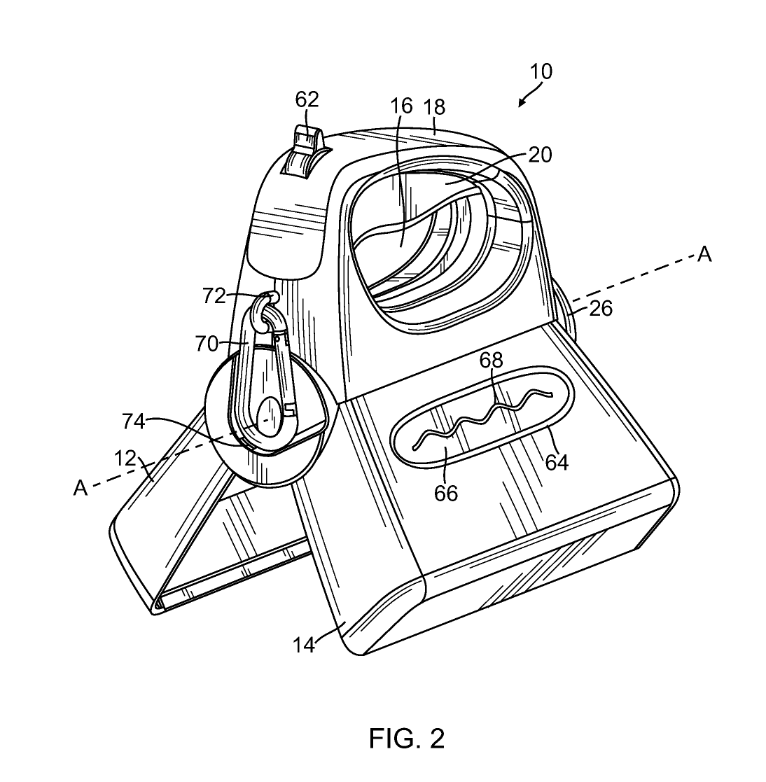

FIGS. 1 and 2 show a perspective view of a waste removal device 10 having features of the invention. Importantly, the device has two opposing clam shell jaws 12, 14, which are configured in relation to the device to normally adopt a closed condition (FIG. 1) in which the jaws are urged by a spring mechanism to close up adjacent each other. When a force is applied to the jaws by a user via an actuation trigger, the jaws are configured to be urged apart from each other while pivoting about a common central axis A-A extending from front to back through the device, as seen in FIG. 2. The normally closed condition (FIG. 1) is the condition pertaining when no external forces are applied to the device. The open condition (FIG. 2) is achieved by inserting a hand through an opening 16 in the device, grasping a looped handle 18 of the device, and squeezing one's hand so as to elevate a trigger 20 toward the handle 18.

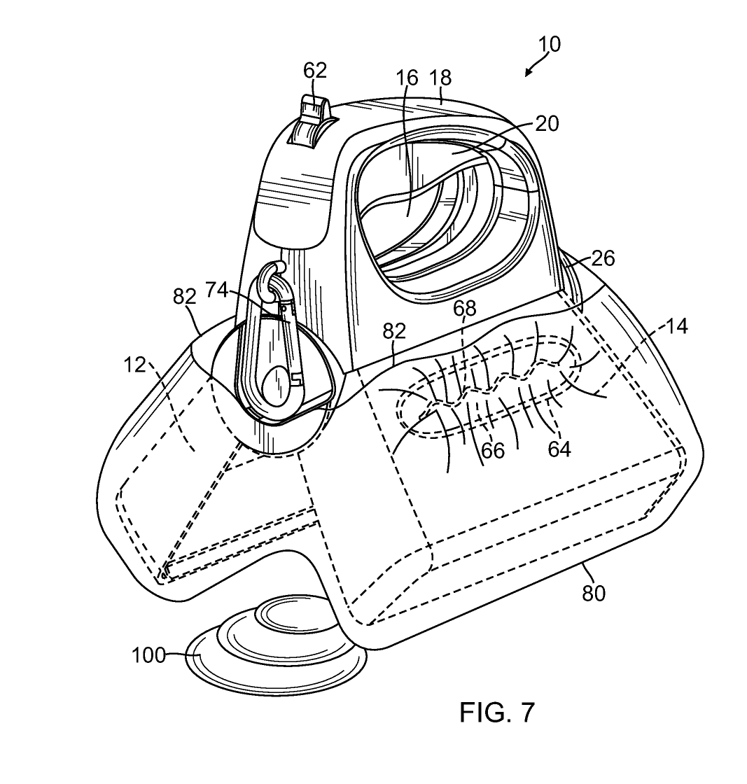

In the open condition when the trigger is manually actuated (FIGS. 2 and 7) the device is configured to be suitable for being placed over pet waste 100 to be removed so that the jaws 12, 14 cover the waste. Preferably, a plastic bag 80 is first stably positioned over the jaws to protect the jaws from contamination. The trigger 20 is then released and an internal spring mechanism closes the jaws so that the waste is contained within the plastic bag 80 which in turn is included inside the shell defined by the jaws 12, 14. The user then pulls the upper ends 82 of the plastic bag 80 downwards and closes or ties the ends with whatever means is available or provided on the bag. At this stage, the waste is within the bag, within the closed jaws. When convenient, he may open the jaws again and remove the plastic bag for disposal in a garbage disposal container.

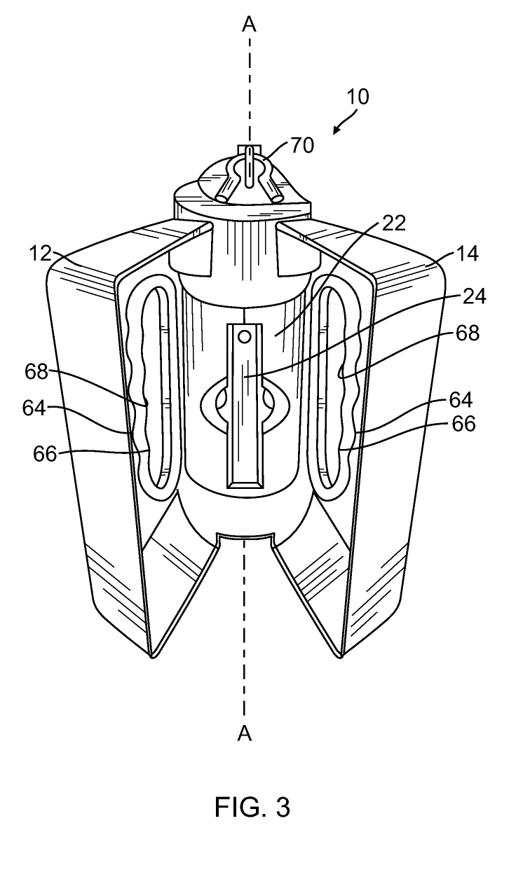

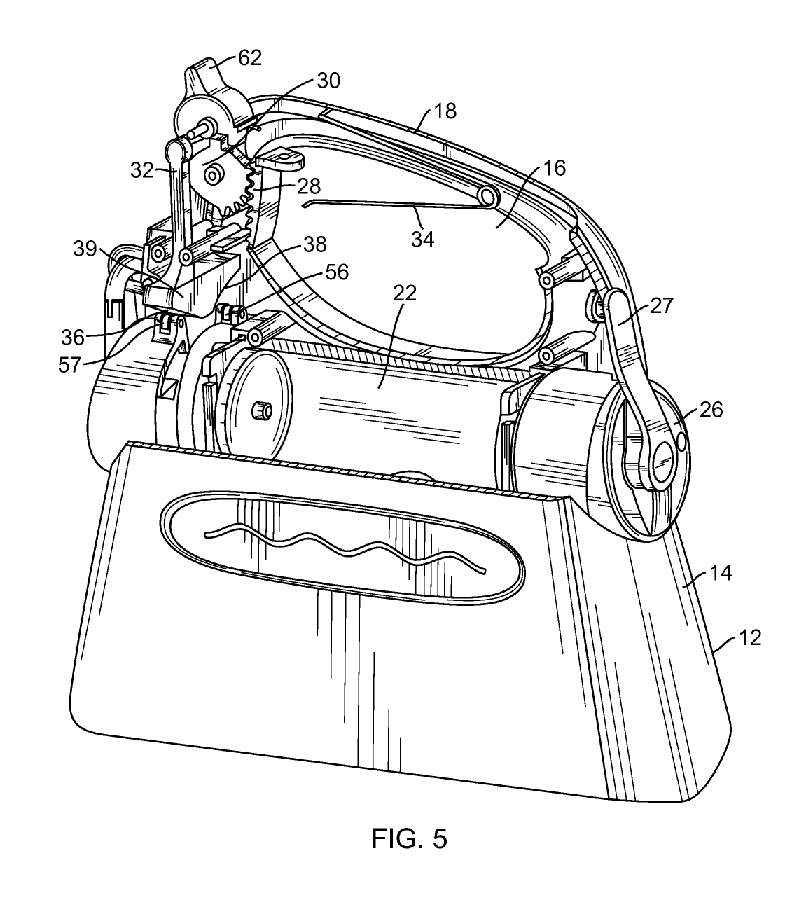

Preferably, a roll of plastic bags joined end-to-end (not shown) may be stored within a cylinder 22 positioned inside the device immediately above the jaws 12, 14, as seen in FIGS. 3 and 5. A slot 24 is cut into the cylinder, preferably the bottom of the cylinder as seen in FIG. 3, and the slot is configured so that a loose end of the roll of plastic bags is extendable from the slot thereby allowing the user to conveniently reach his hand between the opened jaws and pull a fresh bag on the roll of bags, after which he may tear the fresh bag from the roll. A cap 26 is provided for sealing the open end of the cylinder 22 so as to secure the roll of bags inside the device 10. A tether 27 may be provided to prevent the cap 26 from becoming remotely separated from the device 10. A novel means for attaching a fresh bag 80 to the device 10 to protect the jaws during operation is described further below.

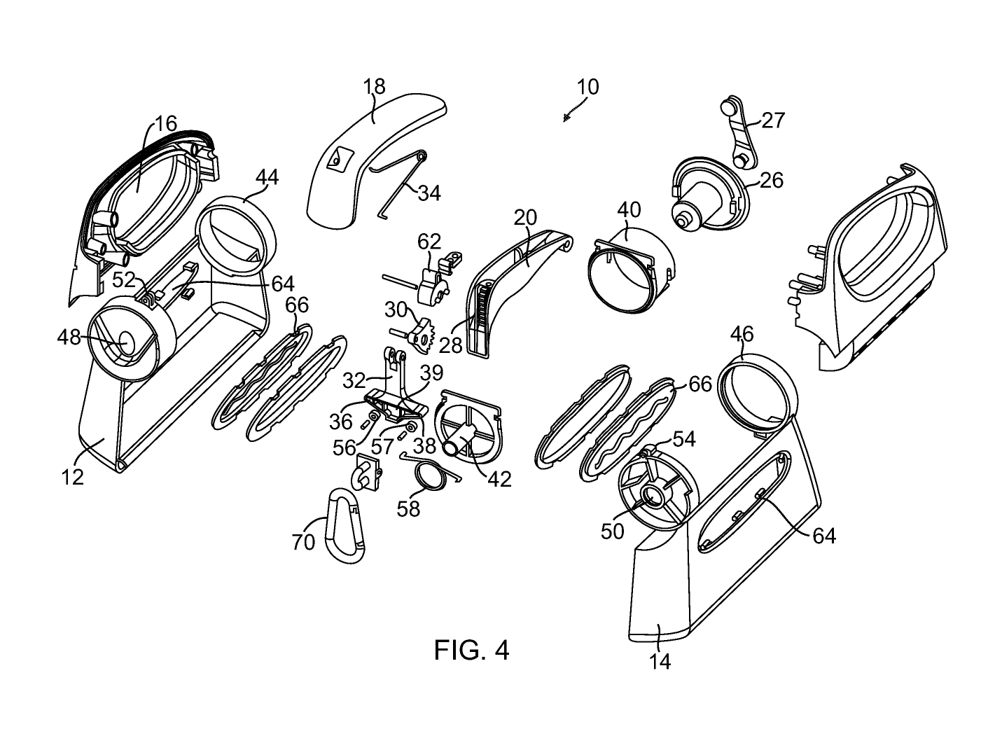

Turning now to FIGS. 4-6, and 8-11 there is exemplified a preferred and novel mechanism of the device that enables activation of the jaws 12, 14 between closed and open conditions while providing a robust and repeating action mechanism. Included on a surface of the trigger 20 is a linear ratchet 28 which has teeth configured to mate with radially positioned teeth on a first toothed end of pivoting gear or lever 30. The pivoting lever 30 is pivotably pinned at its midpoint to the housing of the handle 18. Thus, when the trigger 20 is elevated by hand from its lower starting position, the teeth of the linear ratchet 28 pull upwardly to rotate the first end of the lever 30 upwardly, thereby forcing a second end opposite the first end of the lever 30 downwardly. The second end of the lever 30 is pin-connected to a vertically oriented plunger 32. Therefore, elevating the trigger 20 forces the plunger 32 downwardly. When upward manual force on the trigger 20 is released, a spring 34 forces the trigger downwardly to its starting position, thereby elevating the plunger 32 upwardly to its starting position.

As seen in FIGS. 4-6 the plunger 32 has a specially configured shape. Specifically, the plunger includes two downward facing surfaces 36, 38 that are angled to slope upward from a low point near a vertical centerline of the plunger, thence upwardly toward the outer edges of the plunger, to define a downward pointing wedge shaped configuration 39. This shape is specially configured to interact with portions of the two clamshell jaws 12, 14 (as described below) whereby elevating the trigger 20 forces the plunger 32 downward and this in turn forces the clamshell jaws to an open condition as seen in FIG. 2. This result is achieved because the device 10 has the following structure in relation to the plunger 32 and its wedge shaped configuration 39.

Internal to the device 10 there is positioned a rearward barrel 40 having a relatively large outer circumferential cylindrical surface. Also internal to the device there is positioned a forward barrel 42 having a relatively small outer circumferential cylindrical surface. Each clamshell jaw 12, 14 has a rearward cylindrical hoop 44, 46 respectively, that is sized to fit snugly over the rearward barrel 40, with one hoop in front of the other. Each clamshell jaw also has a forward cylindrical hoop 48, 50 respectively, that is sized to fit snugly over the forward barrel 42, with one hoop in front of the other. With this configuration, the two jaws 12, 14 when mounted on the rearward barrel 40 and forward barrel 42, may rotate about the two barrels between the closed and the open configurations, each jaw rotating about the same common axis A-A of rotation (seen in FIGS. 1 and 2) that extends from the front of the device to the back of the device.

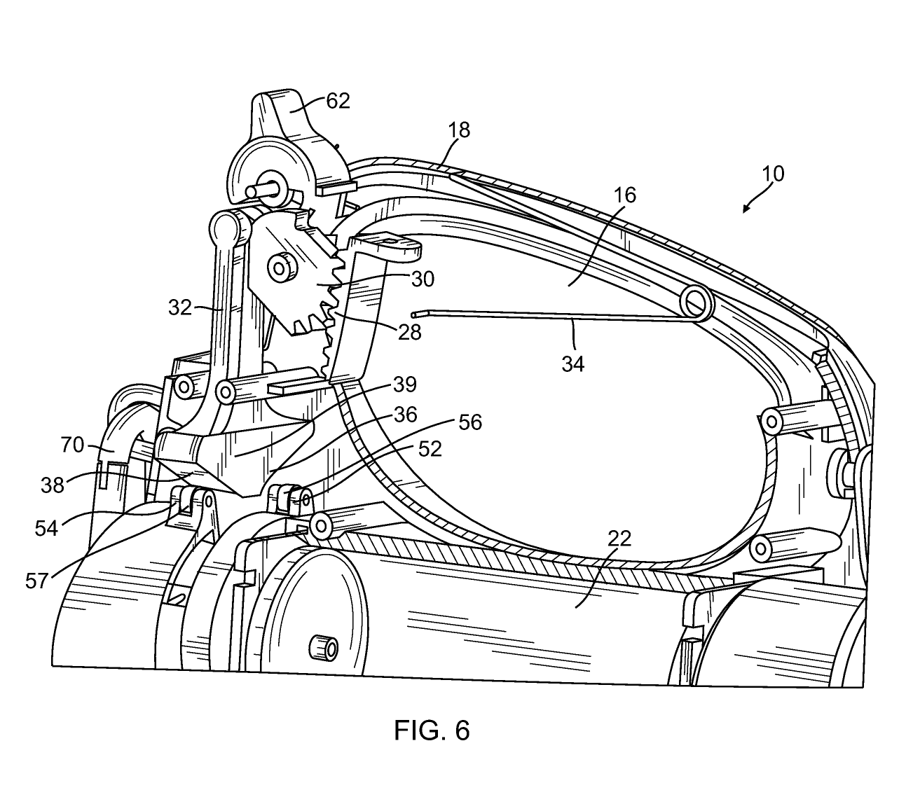

Included on each of the forward hoops 48, 50 of the clamshell jaws 12, 14 is a protrusion 52, 54 respectively. Preferably, a small metal wheel 56, 57 is inserted into each protrusion 52, 54 respectively and held by an axial pin so that each wheel presents a rotatable outer surface disposed on each of the forward cylindrical hoops 48, 50. Once the mechanism of the device is fully assembled (FIGS. 5 and 6), the two sloping surfaces 36, 38 are brought to bear against each of the rotatable surfaces of the wheels 56, 57 when the device is in its normally closed condition. When the plunger 32 is forced downwardly, a sideways vector is imparted by the sloping surfaces 36, 38 which forces the wheels 56, 57, and hence the protrusions 52, 54, to move apart from each other. This sideways movement of a component of each of the clamshell jaws 12, 14 forces the jaws to rotate around the rearward 40 barrel and the forward barrel 42, so that the jaws are forced to swivel open about common axis A-A when the plunger 32 is forced downwardly. A spring 58 is positioned to close the jaws together to their closed condition when the plunger is withdrawn upwardly and the force opening the jaws is withdrawn

Thus there has been described a novel configuration for opening and closing clamshell jaws of a waste removal device that is easy to manufacture, easy to assemble, is highly robust to overcome problems found in the prior art.

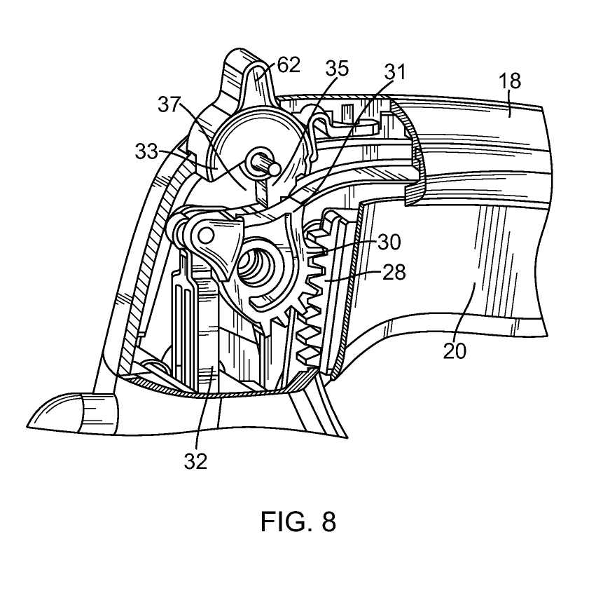

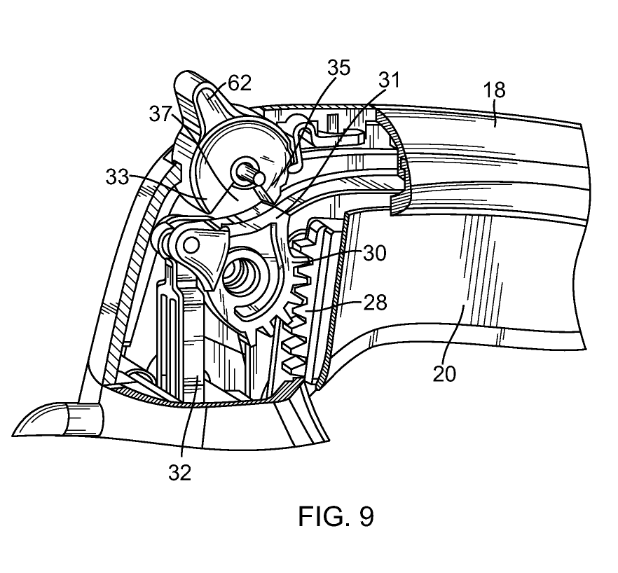

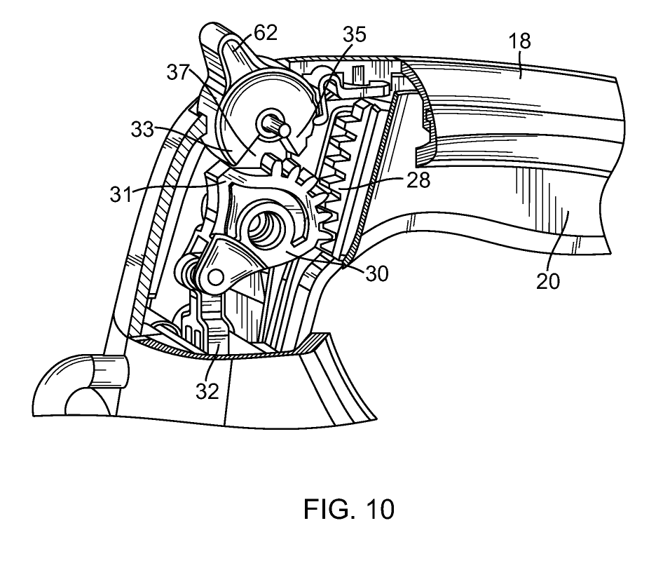

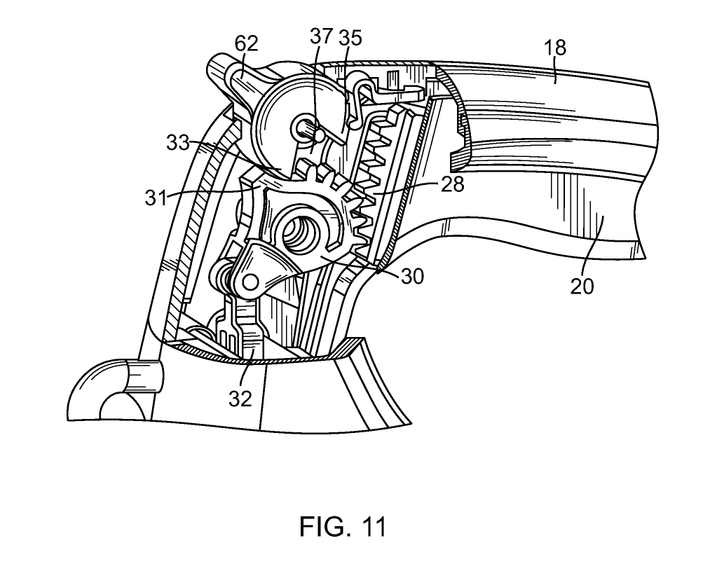

Turning now to FIGS. 5 and 6, and 8-11 a further aspect of the invention is disclosed. A manually rotatable lever or button 62 is pivotably pinned to the handle 18 that has three different settings. A rearward setting of the button locks the jaws closed if the jaws are closed when the button is toggled to the rearward position. (FIG. 8.) A middle setting of the button allows the jaws to be freely opened and closed. (FIGS. 9 and 10.) A forward setting of the button locks the jaws open if the jaws are open when the button is toggled to the forward position. (FIG. 11.) These three settings provide the device with considerable advantages. The “locked closed” condition allows the user to first collect animal waste between the jaws 12, 14 and then to lock the jaws in the closed condition until convenient to dispose of the waste. This feature prevents accidents which may occur if the jaws are accidentally opened when there is waste stored within. The “locked open” condition allows the user to first open the jaws and then to lock them open while positioning a plastic bag over the jaws. This prevents the jaws from inconveniently snapping shut during the procedure. Finally, the intermediate “unlocked” condition allows the user to manually open and close the jaws during a waste removal operation.

As may be appreciated with reference to FIGS. 5 and 6, and 8-11 the described three functional positions of the pivoting button 62 may be enabled by shaping an internal portion of the pivoting button 62 to cooperate with an internal protrusion 31 of the pivoting lever 30 so that when the jaws are open, a forward setting (FIG. 11) of the button blocks the pivoting lever 30 from further movement, thereby locking the jaws in an open condition. A similar effect is achieved for locking the jaws in the closed condition, when the button is moved to a rearward position (FIG. 8). A middle position (FIGS. 9 and 10) of the button 62 allows the pivoting lever 30 to move freely back and forth without hindrance by the button 62, and is used when waste is being collected. In a preferred embodiment, the pivoting button 62 defines a circular shape that has a sector 37 cut out of the circular shape. Flanking the cut out sector 37 is a forward stub 33 and a rearward stub 35.

Movement of the button 62 to a rearward position when the ratchet 28 is in a lowered position (FIG. 8) causes the rearward stub 35 to engage the protrusion 31 of the pivoting lever 30, so that the pivoting lever is locked against counterclockwise rotation, thus locking the plunger 32 against downward movement, and thus locking the jaws 12, 14 in a closed condition, as exemplified in FIG. 1.

Movement of the button 62 to a middle position (FIGS. 9 and 10) causes both forward stub 33 and rearward stub 35 to be disengaged from the protrusion 31 of the pivoting lever 30. Thus, the pivoting lever is free to move through the cut out sector 37 of the pivoting button 62, and a user is free to elevate and lower the trigger 20, thereby sliding the ratchet 28 upwardly or downwardly to freely rotate the pivoting lever 30, thereby to elevate or lower the plunger 32, and thereby open or close the jaws 12, 14.

Movement of the button 62 to a forward position when the ratchet 28 is in an elevated position (FIG. 11) causes the forward stub 33 to engage the protrusion 31 of the pivoting lever 30, so that the pivoting lever is locked against clockwise rotation, thus locking the plunger 32 against upward movement, and thus locking the jaws 12, 14 in an open condition, as exemplified in FIG. 2.

Turning to FIGS. 1-3 and 7, another aspect of the invention is described, namely, a novel provision in the form of a clasp for securely fastening a plastic bag onto the device 10 so that the bag surrounds the jaws 12, 14 when the pet waste is picked up. As noted above, one of the problems in the art is to provide a connector for attaching the bag to the device that will allow the user to use only one hand for that purpose and allow him or her to hold the device in the other hand while so doing. To this end, a novel and advantageous clasp is described with reference to the drawings. At least two openings 64 (best seen FIG. 4) are cut into the walls of the device 10, preferably into a wall of each of the jaws 12, 14. A sheet of rubberized or polymerized material 66, that is preferably a sheet of rubber, or any natural or synthetic polymer material having a high coefficient of friction, is formed to be stretched across the openings 64. This polymer material may be glued to each jaw across the openings 64, but in a preferred embodiment it is mechanically connected. A non-linear slot 68 is cut into the polymer material as exemplified in FIGS. 1, 2, and 5. Preferably, the length of the slot is sufficient to permit at least two fingertips of the user's hand to be inserted through the slot, the material 66 being flexible enough to allow the fingertips to penetrate the slot, thereby allowing the fingertips to drag a sheet of the bag 80 through the slot, such that the sheet remains in the slot when the fingertips are removed, as seen in FIG. 7. In a preferred embodiment, the slot is between 1.5 inches and 3.5 inches long. The non-linear shape of the slot is preferably wave-like, or approximately sinusoidal, as seen in the figures, so that any flat portion of a plastic bag 80 that is inserted into the slot is caused to deform to the shape of the wave as seen in FIG. 7. This has the effect of enhancing the frictional gripping or clasping of the bag 80 and preventing it from easily being removed from the slot once it is inserted therein.

Thus, in use of the device 10, the user may open the jaws 12, 14 by squeezing the trigger 20 upwardly against the handle 18, thereby opening the jaws (FIG. 2) according to the above description. He may then set the button 62 in the forward position (FIG. 11) to lock the handle in the open condition. The user may then disconnect a bag from the roll of bags (not shown) that is stored in the cylindrical cavity 22 located above the jaws, by pulling a loose end of a terminal bag on the roll through the slot 24 in the cavity, and then tearing off the terminal bag. He then pulls the separated bag up over the jaws 12, 14 so that the device 10 itself is partly within the bag as seen in FIG. 7. Then with the fingertips of one hand he inserts the sides of the bag into each slot 68 on the device. It is found that the wave-like or curved nature of the slot 68 in the polymer material securely catches and holds the sides of the bag by frictional retention, so that the bag is well secured onto the sides of the device 10 and encloses the jaws 12, 14. Once the bag is attached to both sides of the device 10 in the described manner, the user may push the bottom of the bag up into the cavity formed by the open jaws, so that the jaws are ready to receive the waste 100 to be collected, while being protected from contamination by the bag as seen in FIG. 7. The user then sets the button 62 at the middle “no lock” setting (FIGS. 9 and 10), which allows him to release any lifting force from the trigger 20. The jaws snap shut under the urging of the spring 58 and the waste is trapped inside the bag between the two jaws. The user then sets the button to the rearward “locked closed” setting (FIG. 8), so that the jaws cannot swing open accidentally before the waste is removed and disposed of. Upon final disposal, the user pulls the upper ends 82 of the plastic bag 80 downwards and closes or ties the ends 82 together with whatever means is available or provided on the bag. At this stage, the waste is still within the closed jaws, within the bag. When convenient, the user may open the jaws again and remove the plastic bag for disposal in a garbage disposal container. In this way, problems in the art associated with opening and closing and disposal are eliminated.

Further features of the invention which are included in a preferred embodiment are a caribiner 70 which is connected to the device by a looped tag 72. The caribiner 70 allows the device to be suspended on a dog leash, or the user's belt, or other suitable point of support. In a further aspect, a detent 74 is provided on the surface of the device to hold the caribiner motionless against the device when desired. When it is desired to use the caribiner 70 for support purposes, the caribiner may be released from the detent 74 by snapping it out of its nested position behind the detent.

Thus, the present invention addresses with novel and useful features certain needs that are found in the art. The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

We claim:

1. A waste removal device comprising:
a handle having a movable actuation trigger;
two opposing jaws, wherein the jaws are adjacent each other in a closed condition when no external force is applied to the actuation trigger, and wherein the jaws are urged apart to an open condition when the actuation trigger is moved by a user;
at least two clasps for clasping a portion of a plastic bag, the clasps being situated on opposite sides of the device, each clasp comprising a sheet of flexible material defining an elongate non-linear slot, the slot being sufficiently long to receive through the slot at least two fingertips of a user's hand.

2. The device of claim 1, wherein the non-linear slot has a wave-like shape.

3. The device of claim 1, wherein the non-linear slot is between 1.5 inches and 3.5 inches long.

4. The device of claim 1, wherein the flexible material is a polymer material.

5. The device of claim 1, further including a pivoting button attached to the device, the button having three settings, namely, a first setting configured to lock the jaws in a closed condition, a second setting permitting the jaws to be moved from a closed condition to an open condition and back to a closed condition, and a third setting configured to lock the jaws in an open condition.

6. The device of claim 1, wherein the device includes a mechanism for moving the jaws from a closed to an open condition, the mechanism including a plunger configured to move linearly downwardly upon actuation of the trigger, the plunger defining a wedge shaped structure configured to force the two jaws to rotate about a common axis of rotation whereby the jaws move apart from each other when the plunger is moved downwardly.

7. The device of claim 1, further including a hollow cylinder within the device for storing a roll of plastic bags.

8. The device of claim 7, wherein the hollow cylinder defines a slot that provides a passage from the interior of the cylinder to a space between the two jaws, whereby the roll of plastic bags is capable of being unraveled and withdrawn through the slot into the space between the two jaws.

9. A waste removal device comprising:
a handle having a movable actuation trigger;
two opposing jaws, wherein the jaws are adjacent each other in a closed condition when no external force is applied to the actuation trigger, and wherein the jaws are urged apart to an open condition when the actuation trigger is moved by a user;
a pivoting button attached to the device, the button having three settings, namely, a first setting configured to lock the jaws in a closed condition, a second setting permitting the jaws to be moved from a closed condition to an open condition and back to a closed condition, and a third setting configured to lock the jaws in an open condition.

10. The device of claim 9, wherein the device includes a mechanism for moving the jaws from a closed to an open condition, the mechanism including a plunger configured to move linearly downwardly upon actuation of the trigger, the plunger defining a wedge shaped structure configured to force the two jaws to rotate about a common axis of rotation whereby the jaws move apart from each other when the plunger is moved downwardly.

11. The device of claim 9, further including a hollow cylinder within the device for storing a roll of plastic bags.

12. The device of claim 11, wherein the hollow cylinder defines a slot that provides a passage from the interior of the cylinder to a space between the two jaws, whereby the roll of plastic bags is capable of being unraveled and withdrawn through the slot into the space between the two jaws.

13. A waste removal device comprising:
a handle having a movable actuation trigger;
two opposing jaws, wherein the jaws are adjacent each other in a closed condition when no external force is applied to the actuation trigger, and wherein the jaws are urged apart to an open condition when the actuation trigger is moved by a user;
a mechanism for moving the jaws from a closed to an open condition, the mechanism including a plunger configured to move linearly downwardly upon actuation of the trigger, the plunger defining a wedge shaped structure configured to force the two jaws to rotate about a common axis of rotation whereby the jaws move apart from each other when the plunger is moved downwardly.

14. The device of claim 13, further including a hollow cylinder within the device for storing a roll of plastic bags.

15. The device of claim 14, wherein the hollow cylinder defines a slot that provides a passage from the interior of the cylinder to a space between the two jaws, whereby the roll of plastic bags is capable of being unraveled and withdrawn through the slot into the space between the two jaws.
